(19) United States
(12) Patent Application Publication
(10) Pub. No.: US 2026/0058929 A1
(43) Pub. Date: Feb. 26, 2026

(54) DOMAIN NAME RESOLUTION AND NETWORK ROUTING

(71) Applicant: Comcast Cable Communications, LLC, Philadelphia, PA (US)

(72) Inventors: Antony Tauber, Cambridge, MA (US); Charles Helfinstine, Cambridge, MA (US); Mark Feldman, Cambridge, MA (US)

(21) Appl. No.: 18/814,023

(22) Filed: Aug. 23, 2024

(51) Int. Cl. H04L 61/4511; H04L 61/5007; H04L 61/5046

(52) U.S. Cl. CPC H04L 61/4511; H04L 61/5007; H04L 61/5046

(57) ABSTRACT

Methods may comprise receiving, at a Domain Name System (DNS) server, a domain name, determining, based at least on the domain name, a network identifier, causing retrieval, via the DNS server and based on at least a portion of the network identifier, of network routing information associated with a network device, and transmitting, from the DNS server, at least a portion of the network routing information to one or more computing devices.

### BACKGROUND

In the course of networking operations, it is often necessary to gather certain pieces of information about or from many points and parts of a network, including the broader Internet. A typical way of gathering pieces of information includes obtaining information from one or more network devices via one or more command-line interfaces (CLI). The pieces of information often need extensive processing and/or cross-referencing and often overburden the one or more network devices.

Improvements are needed.

### SUMMARY

It is to be understood that both the following general description and the following detailed description are exemplary and explanatory only and are not restrictive. Methods and systems for managing wireless communications are described.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

Example methods may comprise receiving, at a Domain Name System (DNS) server, a domain name. Methods may comprise determining, based at least on the domain name, a network identifier. Methods may comprise causing retrieval, via the DNS server and based on at least a portion of the network identifier, of network routing information associated with a network device. Methods may comprise transmitting, from the DNS server, at least a portion of the network routing information to one or more computing devices.

Example methods described herein may include receiving, at a Domain Name System (DNS) server, a domain name (e.g., host name, uniform resource identifier, uniform resource locator). Methods may include determining, based at least on the domain name, a first network identifier. Methods may include transmitting the first network identifier to a first computing device. Methods may include receiving, at the DNS server, a request for network information. The request may include a second network identifier. Methods may include causing retrieval, via the DNS server and based on at least the second network identifier, of network routing information associated with a network device. The network routing information may include one or more of an indication of nearest neighbor information, least hop information, shortest path information, or lowest latency information. Methods may include transmitting, from the DNS server, at least a portion of the network routing information to one or more of the first computing device or a second computing device. Other embodiments of this aspect include corresponding computer systems, apparatus, and computer programs recorded on one or more computer storage devices, each configured to perform the actions of the methods.

Example methods described herein may include transmitting, from a user device and to a Domain Name System (DNS) server, a request for network information. The request may include an identifier. The DNS server may be configured to retrieve, based on at least the identifier, network routing information associated with a network device. Methods may include receiving, via the DNS server, at least a portion of the network routing information. Methods may include initiating, from the user device, a network communication based on at least the at least a portion of the network routing information. Other embodiments of this aspect include corresponding computer systems, apparatus, and computer programs recorded on one or more computer storage devices, each configured to perform the actions of the methods.

Example methods described herein may include receiving, at an intermediate processing device in network communication with one or more network devices and a Domain Name System (DNS) server, network routing information associated with the one or more network devices. Methods may include processing, via the intermediate processing device, the network routing information to include metadata to create modified network routing information. Methods may include causing the modified network routing information to by stored on a network data store. The DNS server may be configured to access the data store to retrieve the modified network routing information without having to directly communicate with the one or more network devices. Other embodiments of this aspect include corresponding computer systems, apparatus, and computer programs recorded on one or more computer storage devices, each configured to perform the actions of the methods.

These and other features and advantages are described in greater detail below.

### BRIEF DESCRIPTION OF THE DRAWINGS

Some features are shown by way of example, and not by limitation, in the accompanying drawings. In the drawings, like numerals reference similar elements.

FIGS. 1A-1K shows an example environment for providing detailed network data using a Domain Name System (DNS) protocol.

FIG. 2 shows example communication messages in a system for providing detailed network data using a DNS protocol.

FIG. 3 shows an example method in accordance with the present disclosure.

FIG. 4 shows an example method in accordance with the present disclosure.

FIG. 5 shows an example method in accordance with the present disclosure.

The accompanying drawings show examples of the disclosure. It is to be understood that the examples shown in the drawings and/or discussed herein are non-exclusive and that there are other examples of how the disclosure may be practiced.

### DETAILED DESCRIPTION

The accompanying drawings, which form a part hereof, show examples of the disclosure. It is to be understood that the examples shown in the drawings and/or discussed herein are non-exclusive and that there are other examples of how the disclosure may be practiced.

The present disclosure relates to systems and methods for requesting and receiving network data using DNS servers. The present disclosure relates generally to using DNS servers to analyze and provide network routing information, such as detailed Border Gateway Protocol (BGP) information, for traffic routing. The present disclosure contemplates implementations where network routing information and/or states of devices, is accessed by, reported to, and stored by DNS servers. The present disclosure facilitates computing devices, such as user devices, requesting traditional DNS functions, such as domain name resolution, and network routing information from the DNS servers.

The DNS (Domain Name System) provides for a well-structured query format and return of data. By deploying logic via DNS, query and return of data may be configured to retrieve network information such as network routing information. Other information may be used. One example of network information may include information from the BGP (Border Gateway Protocol) table or RIB (Routing Information Base). As one of skill would understand, BGP is an Internet protocol that determines how packets are routed between network equipment and between networks. The BGP system of routing information management and handling includes a datastore where routes are stored. An example datastore includes one or more database collectively referred to as Routing Information Base (RIB). As a further example, the RIB may comprise: Adj-RIBs-In: a set of input database parts that holds information about routes received from peer BGP speakers; Loc-RIB: a core database that stores routes that have been selected by this BGP device and are considered valid by the BGP device; and Adj-RIBs-Out: A set of output database parts that holds information about routes that this BGP device has selected to be disseminated to its peers.

As an illustrative example, the BGP table can and often does vary across the different routers or network devices within the network. As a further example, BGP table information may be exported to a server on a periodic or dynamic basis. As such, the server having access to the BGP table may respond to queries which specify a given identifier (e.g., IP prefix (sometimes called a “route”). The server may respond to queries using various rules sets for retrieving network information. As a non-limiting example, the LPM (Longest Prefix Match) mechanism may be used to determine the “best matching” identifier (e.g., IP prefix) and then return the table information for the best matching identifier. Such return information may be or comprise various forms including, for example, one or more DNS TXT (text) record(s). Other rules and mechanisms may be used to manage queries and return of network information, as described herein.

As an illustrative example, conventional command-line interface (CLI) approaches may apply a processing burden on routers or other network equipment. Additionally, network data may be required promptly in order to process additional routing information and the like. The conventional CLI may have several issues. One of the issues associated with the use of a CLI is that it may necessitate the use of authentication and/or authorization schemes and/or other controls that can increase processing load on network devices. Increasing the processing load on the network devices may compromise network functions of the network devices. Another issue with the use of a CLI is that command structure and output format may vary by vendor, model, software version, etc. There is not a standard set of commands and expected output formats that a user may implement across network devices. Another issue is that the authentication and/or authorization schemes used may cause lag in the attempt to gather pieces of information. The systems and methods of the present disclosure may allow for permissionless access (e.g., without requiring authority from a publisher or network operator) to certain information (e.g. network routing information) through a standardized protocol. The conventional undesirable “overhead” requires every possible user obtain permission from every possible “publisher” (e.g., network operator) to access this information under conventional means. As such, the present disclosure may reduce this overhead and may provide a technical improvement to the access of routing information over a network.

Route servers may comprise a router (CLI). The route servers may receive data unidirectionally from Border Gateway Protocol (BGP) configured routers or other network devices. As explained above, the route servers do not have a standard command structure (e.g., query language, etc.) or output (e.g., result, etc.) format. The route servers may also need a third party, such as an authentication, authorization, and accounting (AAA) server to authenticate and/or authorize a device transmitting a command before the route servers may respond, which may impair performance. The route servers will typically not be purpose built and may be vulnerable.

BGP looking glass servers may receive user submitted queries via a web based graphical user interface (GUI). The BGP looking glass servers may comprise backend capability to query one or more BGP configured network devices, such as by submitting the received queries to BGP configured network devices via a CLI or other remote procedure call (RPC). As previously discussed, exact query language and/or output format from such network devices is not standard. BGP looking glass servers may have back-end rate limits imposed to prevent adverse effects on the BGP looking glass servers themselves and their performance.

In accordance with an aspect of the present disclosure, a Domain Name System (DNS) server may receive information (e.g., unidirectionally) from one or more data sources (e.g., network devices, etc.), such as data stores, Border Gateway Protocol (BGP) configured routers, devices configured to perform intermediate processing on data from BGP configured routers, etc. As an example, unidirectional data flow may protect network information and the network devices from risk of compromise. The DNS server may receive and respond to DNS queries from user devices. The DNS server may inject routing information, such as information from a BGP table received from a BGP configured router, into a DNS response. A user device may use the routing information in the DNS response to establish a connection with a device associated with an associated DNS query.

Using a DNS protocol, internal data sources may send data unidirectionally to one or more DNS server and not be exposed to risks of compromise or performance degradation from outside queries. The performance of the one or more DNS server may be improved from performance enhancing techniques, such as load-sharing, horizontal scaling, etc. Using the one or more DNS server as an interface to external devices enhances network security and performance.

The systems and methods described herein may provide a delegated structure that may allow some or all network operators to participate. Delegation may happen inside a network operator's span of control, such as among organizational units.

The systems and methods described herein may provide structure for information. The DNS server may provide a means to embed Internet Protocol (IP) address notation in DNS “dotted” notation. Further pieces of namespace may be used to delegate to various autonomous system (AS) network operators. The AS network operators may break up the namespace as pleased by location and/or network device. The AS network operators may “publish” the structure of a portion of the namespace handled by a controlled network device using a structured text (TXT) record, which would enumerate a delegation below a root of the portion of the namespace.

The systems and methods described herein may include caching by intermediate nodes. The length of time intermediate nodes cache records may be controlled by an authority for a namespace. The length of time intermediate nodes cache records may be for a set amount of time, in seconds, minutes, hours, etc. The length of time intermediate nodes cache records may be zero, or not at all.

The systems and methods described herein may be used to publish and retrieve BGP data, network inventory, network configuration(s), network state(s), etc. The publishing and retrieval of such network information may allow for efficient use of networking hardware and software. The publishing and retrieval of such network information may allow for optimization of networking hardware and software. The concepts and approaches described herein are flexible and extensible.

The systems and methods described herein may facilitate network governance. The work of Internet network operators may be structured and reflected in a BGP structure. Each “network” may be an AS with AS Number (ASN). Each AS may be defined as “a set of routers under a single technical administration . . . [which] appears to other ASes to have a single coherent interior routing plan and presents a consistent picture of the destinations that are reachable through it.”—Request for Comments (RFC) 4271—A Border Gateway Protocol 4 (BGP-4). Information for each ASN may be located in a DNS hierarchical namespace by reference to an associated ASN. For example, the Internet Corporation for Assigning Names and Numbers (ICANN) and Internet Assigned Number Authority (IANA) may define a place in the DNS structure, such as “network-info.arpa”, where each delegation below (to the left of) a domain may be delegated to a network operator associated with a corresponding ASN. For example, one entity may have a delegation for “7922.network-info.arpa”as well as each other ASN assigned to that entity. “network-info.arpa” is used for illustration purposes only—any appropriate naming convention may be used.

Each network operator of an AS may have a place to publish that could be found without any different “directory” than already exists today with ASNs being handled by the Regional Internet Registries (RIRs): American Registry for Internet Numbers (ARIN), The Latin America and Caribbean Network Information Center (LACNIC), The African Network Information Centre (AFRINIC), Réseaux IP Européens (RIPE), Asia Pacific Network Information Centre (APNIC), and their delegates. Other mechanisms and protocols may be used.

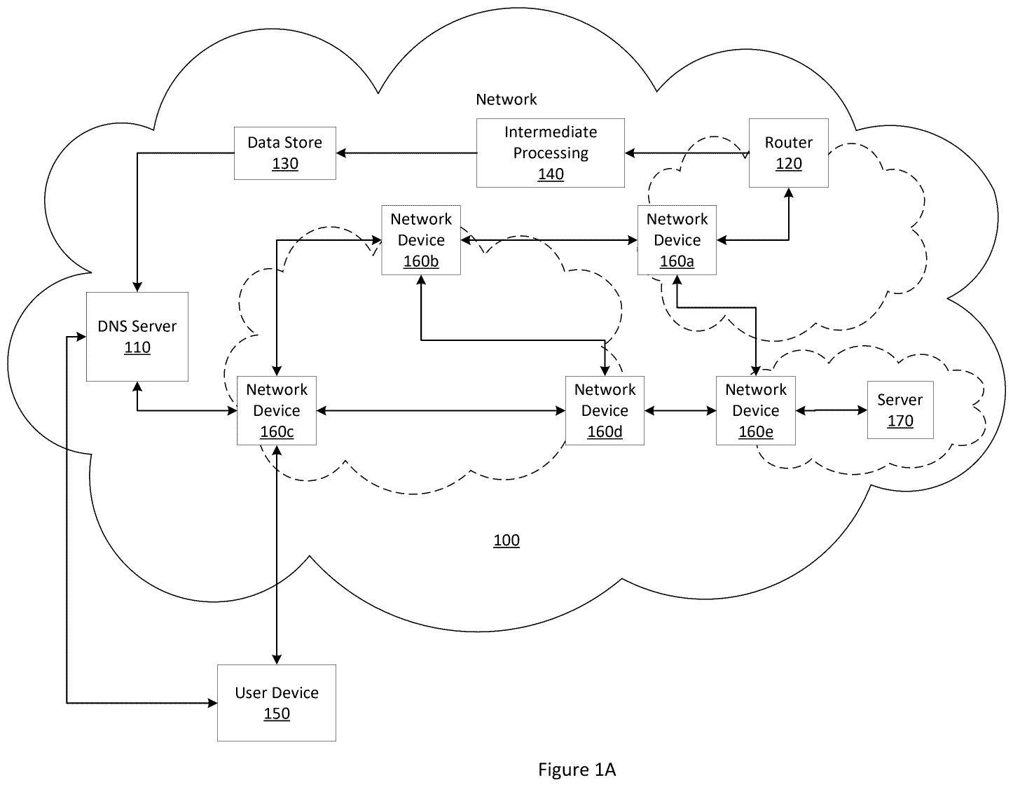

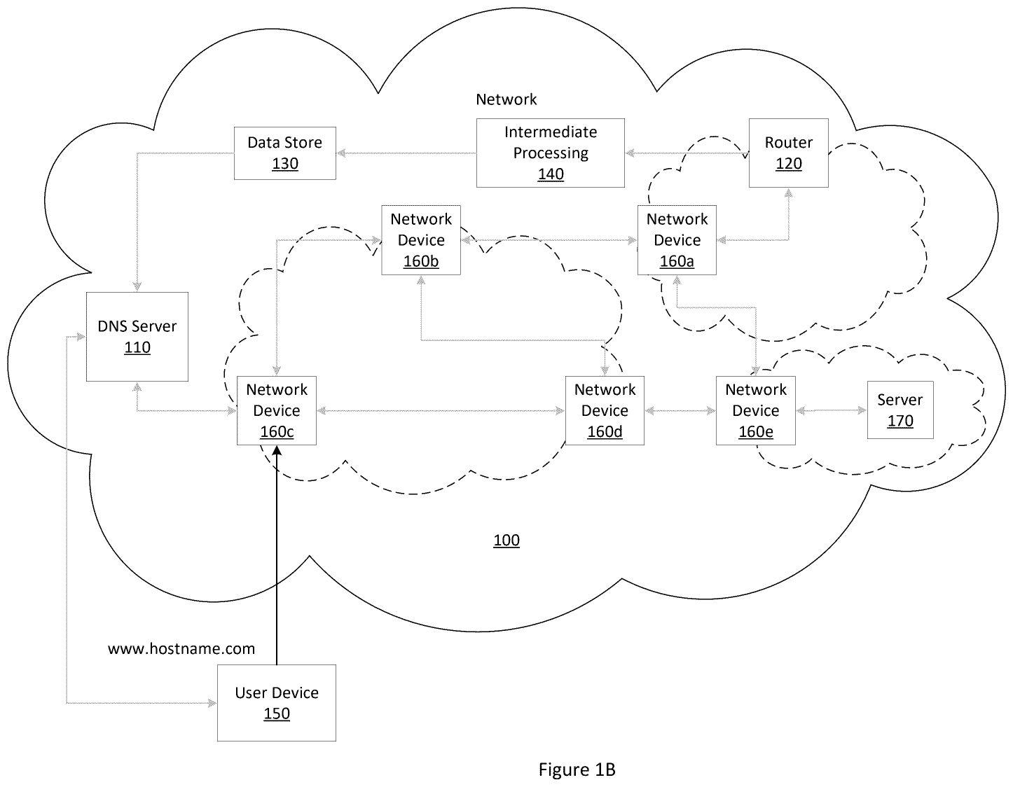

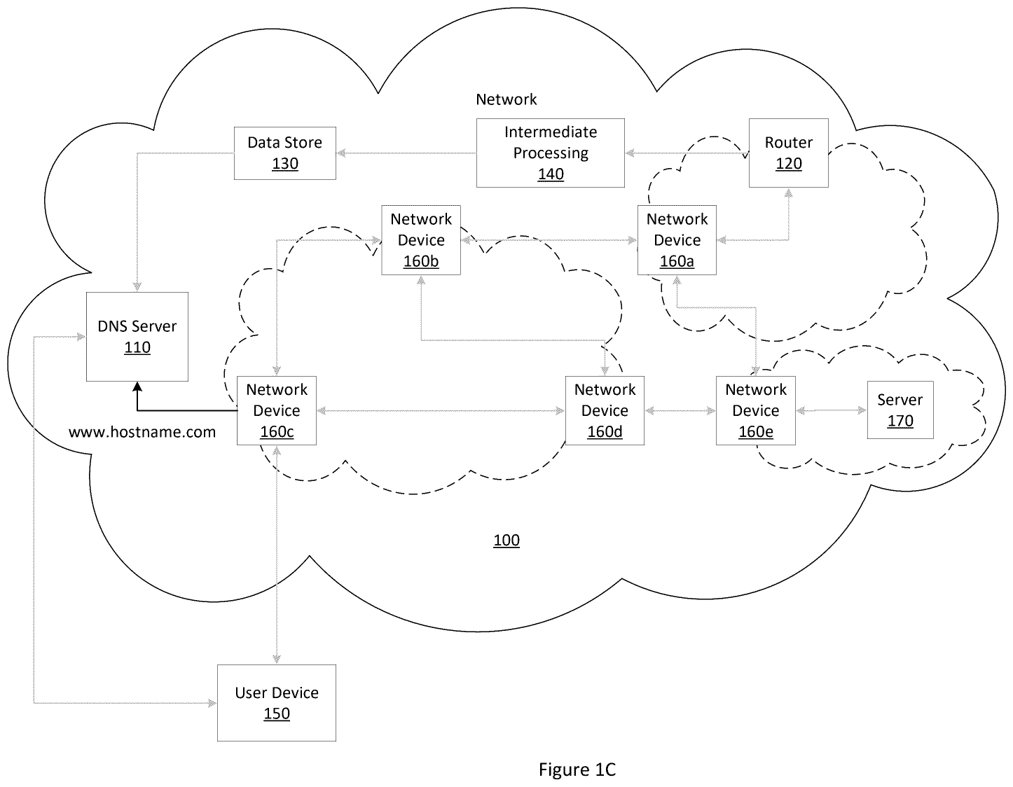

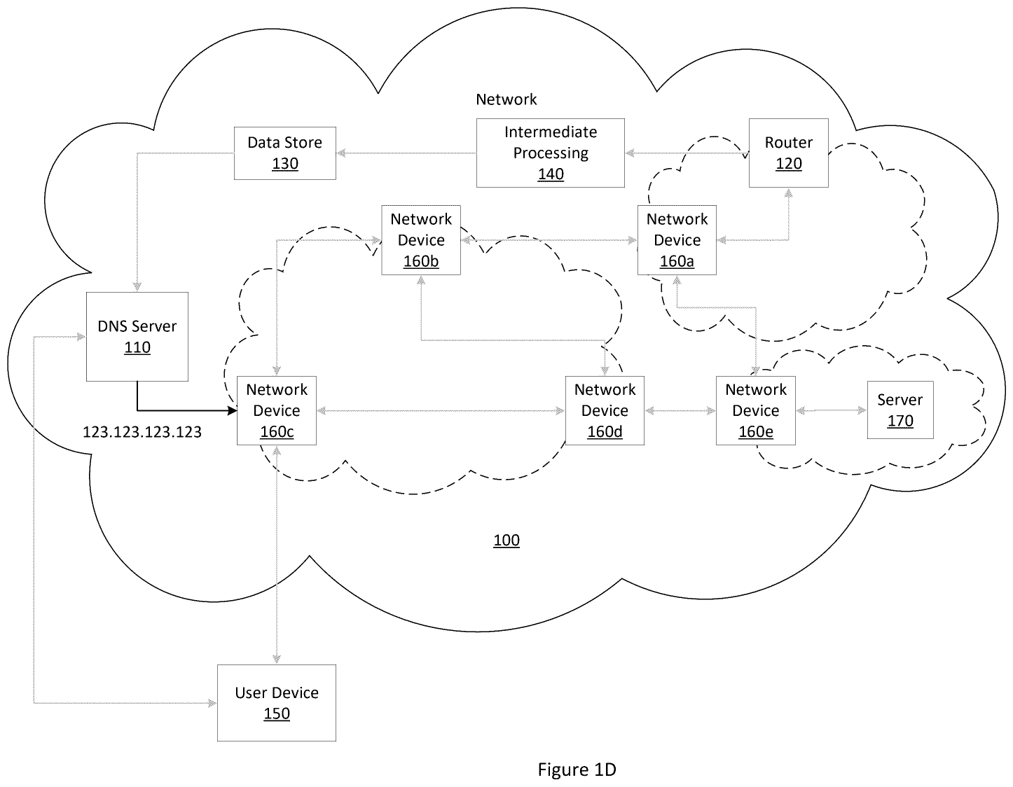

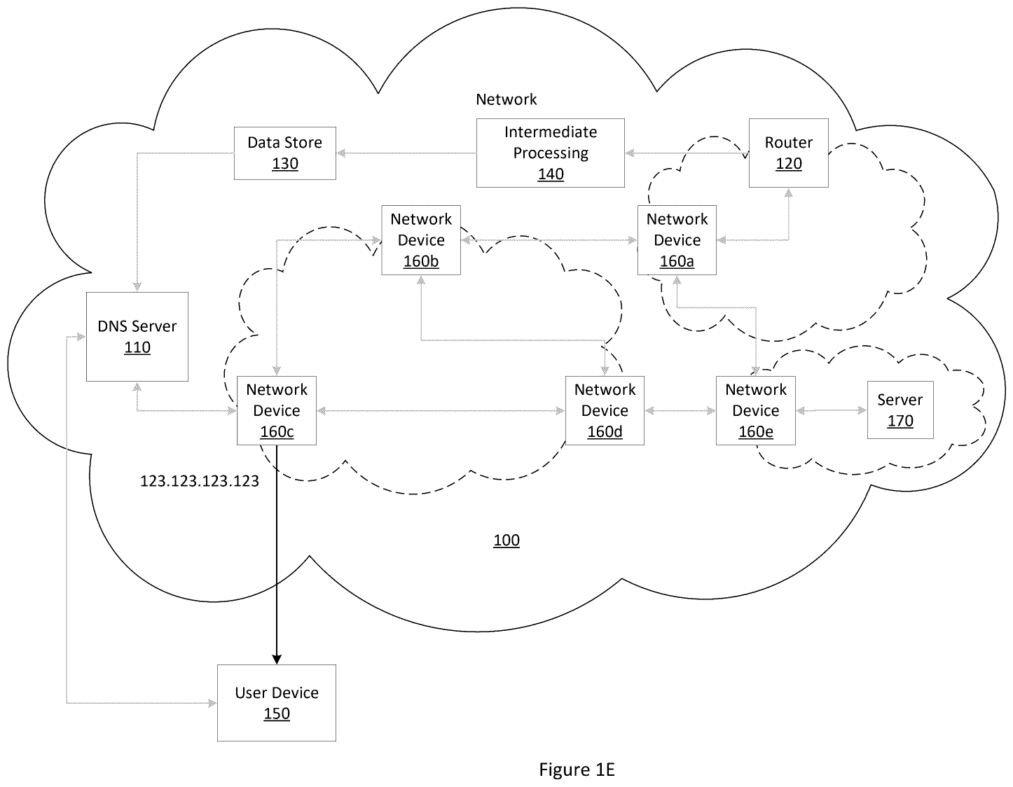

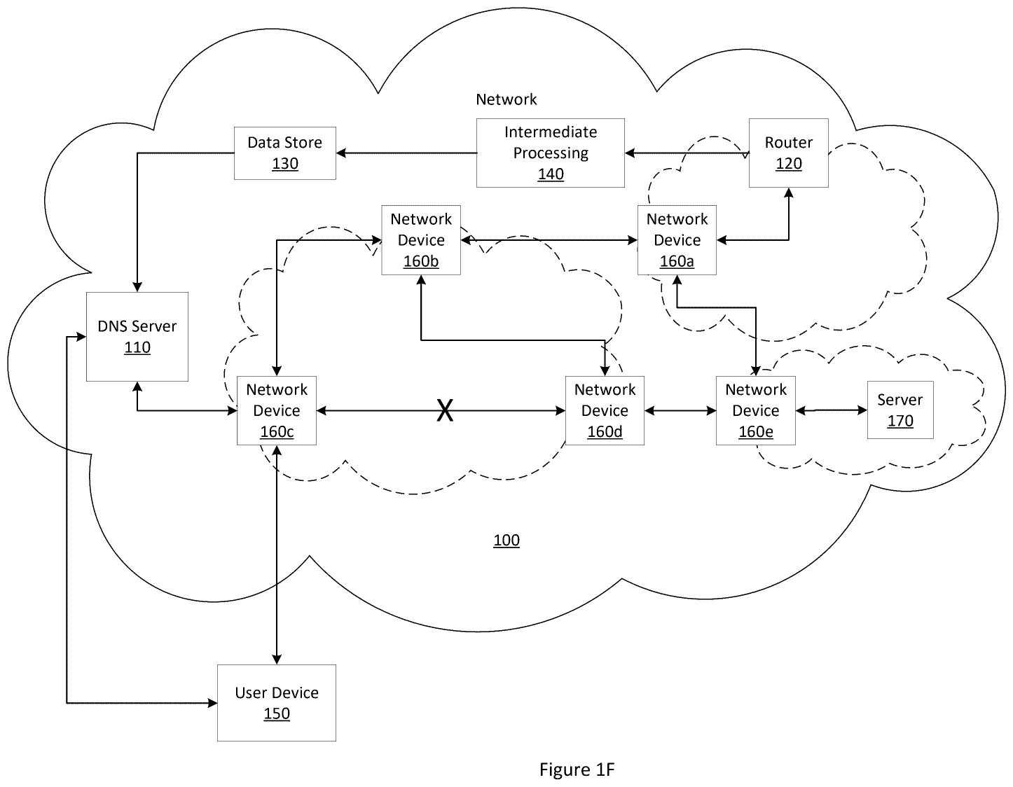

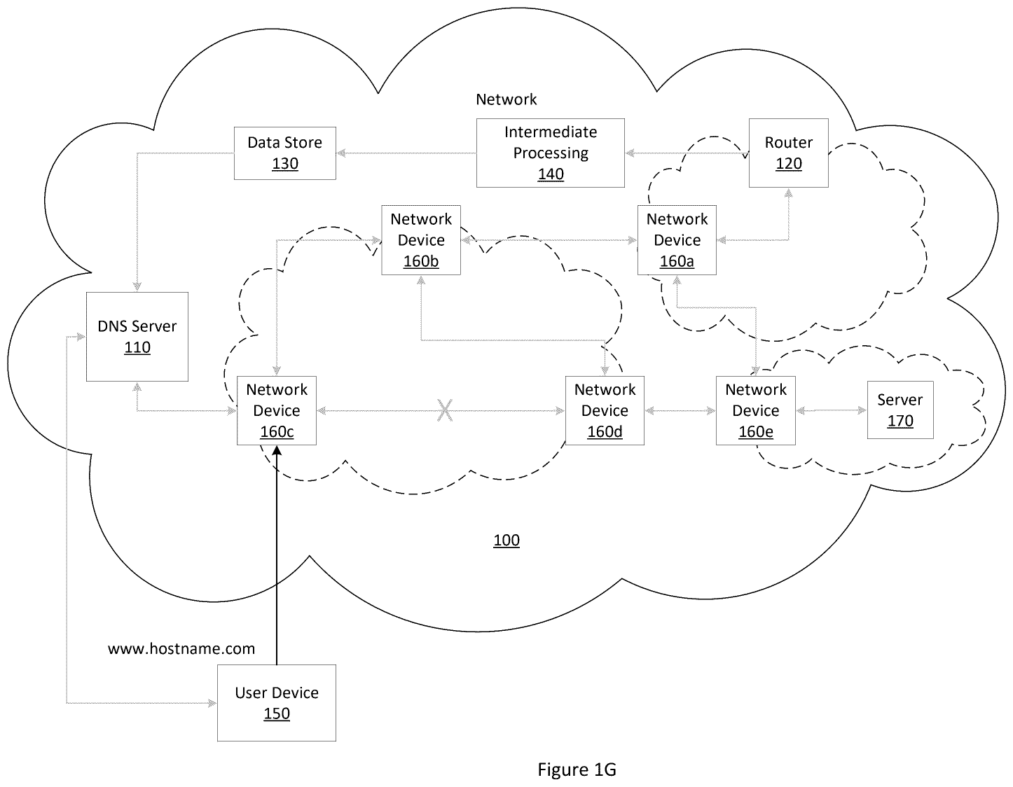

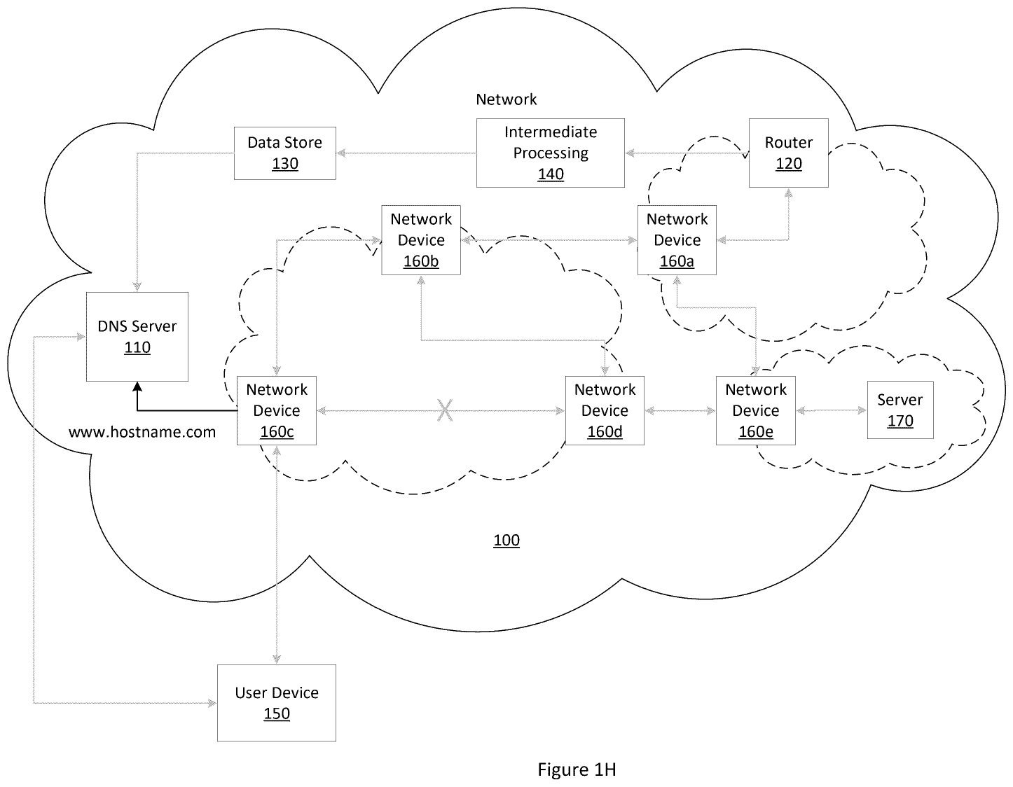

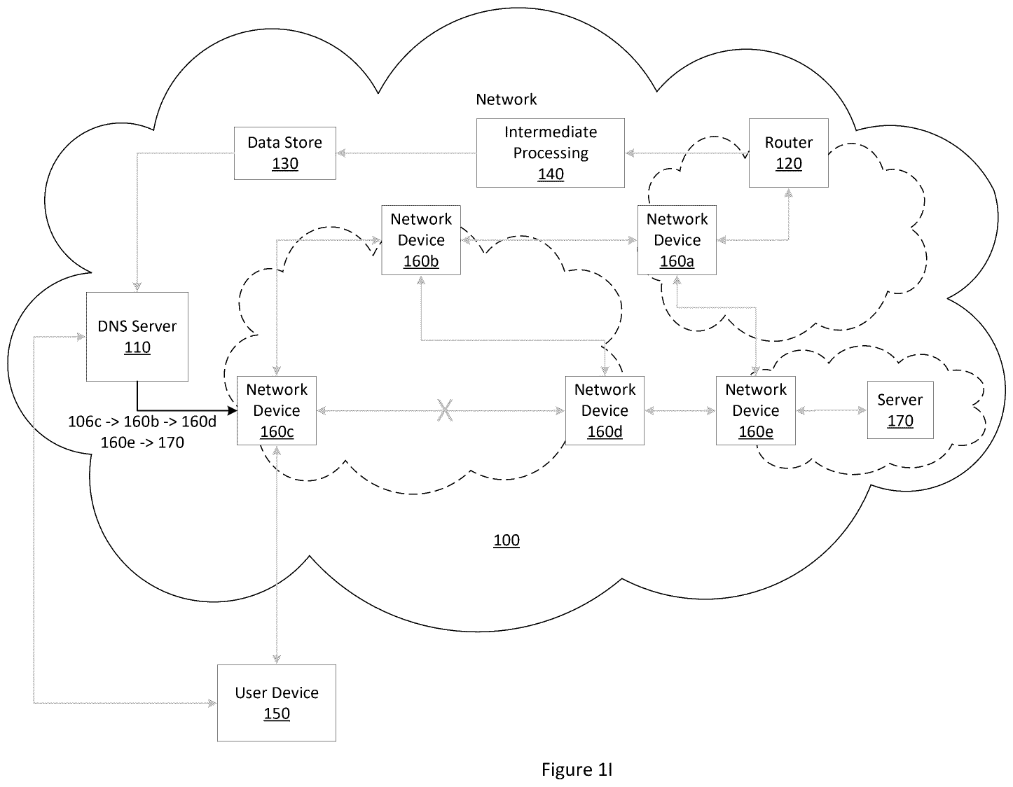

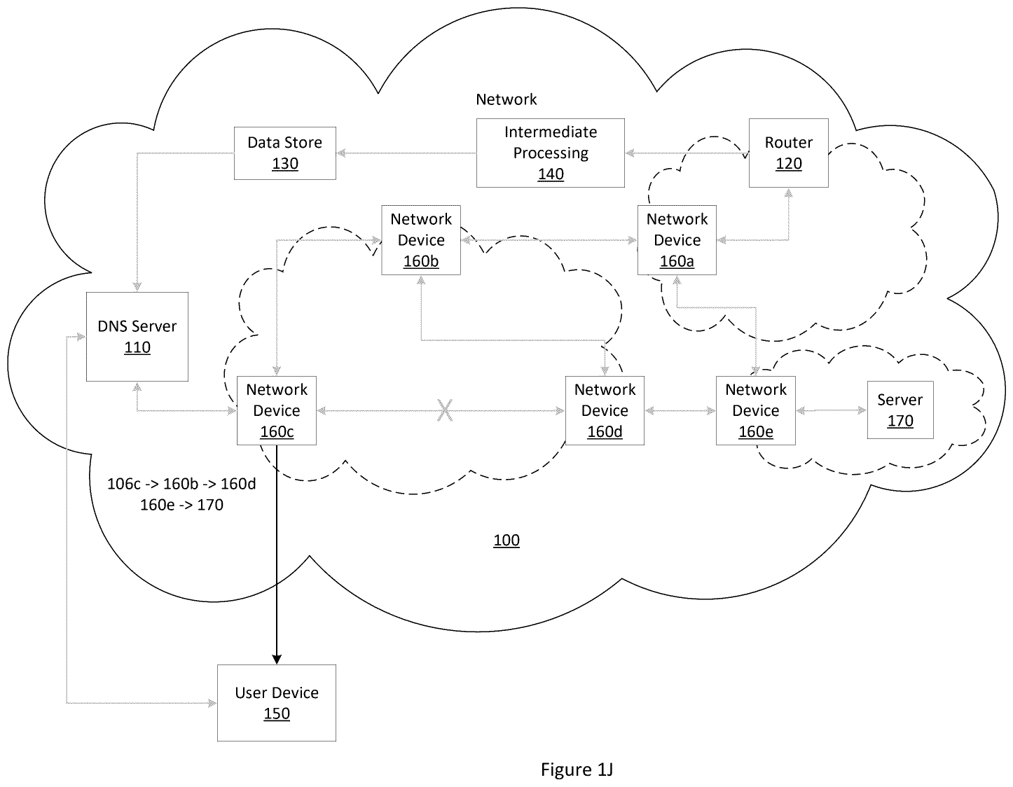

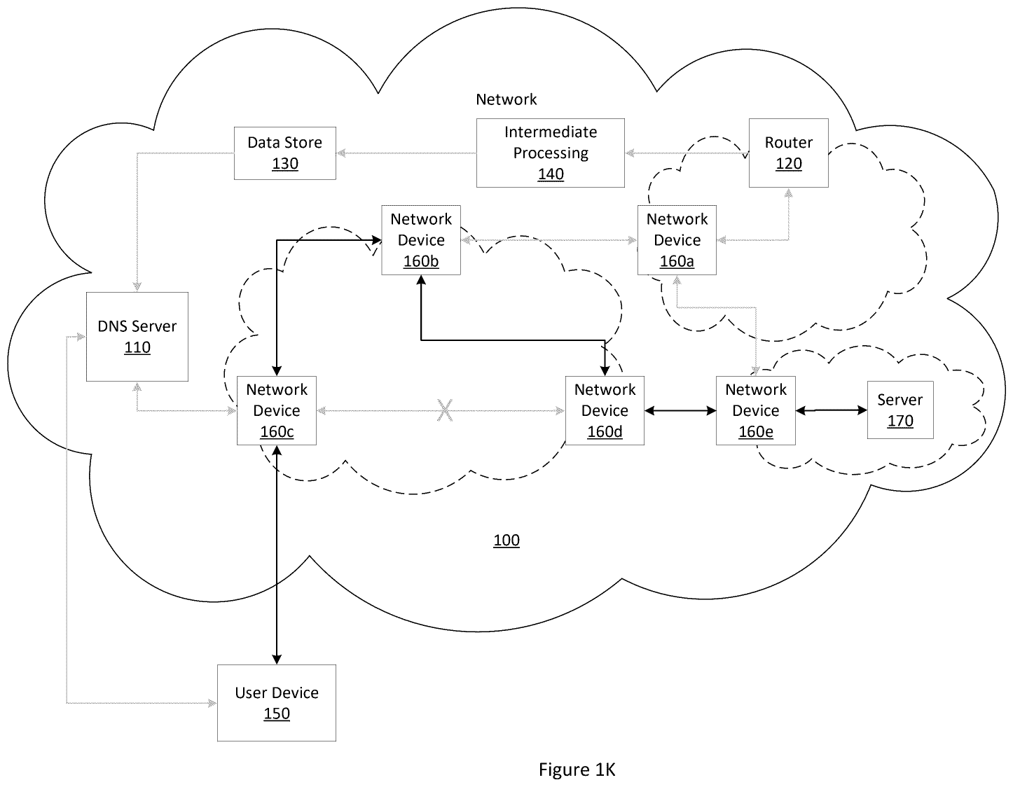

FIGS. 1A-1K show an example environment for providing detailed network data using a Domain Name System (DNS) protocol. Turning first to FIG. 1A, the environment may comprise a network 100 and a user device 150. The network 100 may comprise a DNS server 110, and a plurality of network devices, such as a router 120, a data store 130, an intermediate processing device 140, network devices 160a-160e, and a server 170. The network 100 may comprise one or more private networks or private portion. The plurality of network devices 120, 130, 140, 160a-160e may be internal to the network 100.

The DNS server 110 may provide an interface to the plurality of network devices 120, 130, 140 for the user device 150. The DNS server 110 may perform DNS resolution (translation, conversion, etc.). As an example, the DNS server 110 may receive a request with an domain name (e.g., host name) and transmit a response with a computer-readable network identifier that corresponds to the domain name. The domain name may comprise a host name or other Uniform Resource Locator (URL). The computer-readable network identifier may comprise an Internet Protocol (IP). Additionally or alternatively to DNS resolution, the DNS server 110 may receive, process, and transmit network routing information. The DNS server 110 may receive network routing information, such as Border Gateway Protocol (BGP) information, via the plurality of network devices 120, 130, 140, 106a-c. As shown, the DNS server 110 may have access to network routing information, such as Border Gateway Protocol (BGP) information by communicating with a data store 130, and without requiring a direct query to the router 120.

As an illustrative example, the DNS server 110 may receive an incoming message comprising an identifier, such as an Internet Protocol (IP) prefix address, from the user device 150 and return an outgoing message with a corresponding address, such as an IP prefix address (e.g., route, etc.), and corresponding network routing information, such as Border Gateway Protocol (BGP) information. The corresponding address may comprise a best matching IP address prefix derived from a longest prefix match (LPM) mechanism applied to the identifier. Other rules or matching mechanisms may be implemented, for example, an Exact Prefix Match (EPM). Additionally or alternatively, the identifier in the incoming message may be obfuscated with a mathematical hash algorithm that is known to the DNS server 110 and then interpreted as the correct identifier with the appropriate response. The hash system would hide the identifier from any intermediary who has access to the communications path. The corresponding network routing information may comprise a networking path the user device may cause to be established to communicate with the device associated with the identifier in the incoming message. The network routing information may comprise one or more of nearest neighbor information, least hop information, shortest path information, or lowest latency information.

The router 120 may route data packets. The router 120 may help establish a network path. The router 120 may comprise a node on the established data path. The router 120 may comprise network routing information. The router 120 may comprise a table. The router 120 may comprise a Border Gateway Protocol (BGP) configured router. The table may comprise a BGP table. The network routing information may comprise BGP information. The table may comprise, but not limited to, BGP AS-PATH information, address geo-location information, alternate data forwarding path information, segment routing path information, BGP neighbor state information, route path longevity and change history, DNSSEC signatures for BGP information, and the like. The router 120 may comprise a Routing Information Base configured router. The table may comprise a RIB table. The network routing information may comprise RIB information. The router 120 may transmit network routing information directly to the DNS server 110. The router 120 may transmit network routing information to the intermediate processing device 140 for processing of network routing information before ultimate delivery to the router DNS server 110.

The data store 130 may comprise a database. The data store 130 may comprise network routing information. The data store 130 may comprise a table. The data store 130 may comprise a Border Gateway Protocol (BGP) configured data store. The table may comprise a BGP table. The network routing information may comprise BGP information. The data store 130 may comprise a Routing Information Base configured data store. The table may comprise a RIB table. The network routing information may comprise RIB information. The data store 130 may transmit network routing information directly to the DNS server 110.

The intermediate device 140 may be configured to process data, such as network routing information, from the router 120. The intermediate processing device 140 may be configured to process BGP data. The intermediate processing device 140 may be configured to process RIB data. The intermediate processing device 140 may be configured to process data organized in data structures, such as tables. The intermediate device 140 may be configured to organize data into a data structure, such as a table. The intermediate processing device 140 may be configured to resolve conflicts in network routing information received from routers. The intermediate processing device 140 may be configured to cache data received from the router 120. The intermediate processing device 140 may aggregate routing data from one or more routers (e.g., router 120) across a network and may combine the aggregated data into a unified data structure. The intermediate processing device 140 may enrich the data with additional meta data such as geo-location or topology information to show details on the source of the data. Other meta data and information may be added. The intermediate processing device 140 may add timing information indicating when the data was retrieved from a given router (e.g., router 120). The intermediate processing device 140 may be configured to calculate Domain Name System Security Extensions (DNSSEC) signature records for the data to validate the authenticity of the data to end users. The intermediate processing device 140 may calculate alternate paths for routing flows through the network. The intermediate processing device 140 may be configured to manage the periodic retrieval of all types of data from one or more routers (e.g., router 120). The retrieval period may be undefined or may be fixed or vary over a timing algorithm based on time of day, day of week, or month of year. Other operations may be implemented via the intermediate processing device 140.

The user device 150 may comprise a smart phone, tablet, wearable computing device, laptop, desktop, etc. The user device 150 may comprise an application, such as a web browser. The application may need to communicate with a remote computing device. The application may cause the user device 150 to transmit a request with an identifier associated with the remote computing device to the DNS server 110 via the network 100. The DNS server 110 may retrieve an IP address prefix and network routing information associated with the remote computing device. The DNS server 110 may have previously received the network routing information from the data store 130. The DNS server 110 may transmit a message to the user device 150 via the network 100 wherein the message comprises the IP address prefix and the network routing information. The user device 150 may use the network routing information and IP address prefix to establish a connection in the network 100 with the remote computing device. The application may retrieve data from and/or transfer data to the remote computing device via the established connection.

The network devices 160a-160e may comprise any device configured to facilitate network communication, such as a router, bridge, switch, repeater, intermediate processing device, data store, etc. The network devices 160a-160e may comprise network addresses, such as IP addresses. A sub-network may comprise two or more of the network devices 160a-160e comprising a common trait. For example, network device 160b may comprise an IP address of 123.0.2.2, network device 160c may comprise an IP address of 123.1.1.1, network device 160d may comprise an IP address of 123.123.0.3, and a sub-network comprising network device 160b, network device 160c, and network device 160d may comprise network devices comprising IP addresses starting with 123 (123.xxx.xxx.xxx).

The server 170 may comprise one or more computing devices configured to provide content accessible via the network 100. The server 170 may reside in a cloud computing environment. The router 120 and the server 170 may be described more generally as network devices, such as network devices 160a-c.

FIGS. 1B-1E show an example DNS resolution (translation, conversion, etc.) procedure. Turning first to FIG. 1B, the user device 150 may transmit a request to the network device 160c. The request may comprise an domain name. The domain name may comprise a hostname. The domain name may comprise a uniform resource identifier (URI) or a uniform resource locator (URL), such as www.hostname.com. Turning to FIG. 1C, the network device 160c may forward (transmit, route, etc.) the request to the DNS server 110. The network device 160c may extract the domain name from the request and create a new message comprising the domain name for transmission to the DNS server 110. Although FIGS. 1B and 1C show the network device 160c as an intermediate device between the user device 150 and the DNS server 110, the user device 150 may transmit the domain name to the DNS server 110 via a direct connection between the user device 150 and the DNS server 110.

Turning to FIG. 1D, the DNS server 110 may receive the request comprising the domain name. The DNS server 110 may receive the new message comprising the domain name. The DNS server 110 may extract the domain name from the request and/or the new message. The DNS server 110 may use the domain name to retrieve a corresponding computer-readable network identifier. The corresponding computer-readable network identifier may comprise an Internet Protocol (IP) address, such as 123.123.123.123. Using the domain name to retrieve a corresponding computer-readable network identifier may comprise applying the domain name to a lookup table and retrieving a value in the lookup table corresponding to the domain name. The DNS server 110 may transmit a response to the network device 160c, wherein the response comprises the computer-readable network identifier.

Turning to FIG. 1E, the network device 160c may forward the response to the user device 150. The network device 160c may extract the computer-readable network identifier and create a new response with the computer-readable network identifier and forward the new response to the user device 150. The user device 150 may receive the response and/or the new response and extract the computer-readable network identifier from the received response and/or new response. The user device 150 may use the computer-readable network identifier to create a communication connection between the user device 150 and a device comprising the computer-readable network identifier. Although shown as forwarding the computer-readable network identifier to the user device 150 in FIG. 1E, in another embodiment, a network device, such as network device 160c, may use the computer-readable network identifier to facilitate communication between the user device 150 and a device comprising the computer-readable network identifier. Although FIGS. 1D and 1E show the network device 160c as an intermediate device between the user device 150 and the DNS server 110, the DNS server 110 may transmit the computer-readable network identifier to the user device 150 via the direct connection between the user device 150 and the DNS server 110.

FIGS. 1F-1K show an example procedure involving the DNS server 110 providing network routing information. Turning to FIG. 1F, the various network devices (router 120, data store 130, intermediate processing device 140, and network devices 160a-160c) may provide network information to the DNS server 110 and/or one or more of each other. The network information may comprise node information, path information, etc. Connection information may comprise connection latency information, connection availability information, connection cost information, connection security information, connection association information, etc. Node information may comprise node status information, nearest neighbor information, node latency information, node availability information, node cost information, node security information, node association information, etc.

The DNS server 110 and/or the one or more of the various network devices may use the network information to create network routing information. Network routing information may comprise information regarding a route between two devices. A route may comprise a start device, an end device, a plurality of intermediate devices, and a plurality of intermediate connections. A route may comprise n number of connections and n+1 number of devices. The start device of a route may comprise one connection, the end device of the route may comprise one connection, and the intermediate devices of the route may comprise two connections. The network information may indicate that a connection between the network device 160c and the network device 160d is broken. The network information indicating that the connection between the network device 160c and the network device 160d is broken may be propagated throughout the various network devices in the network 100. The DNS server 110 and/or other network devices in the network 100 that are configured to create network routing information may exclude a direct connection between the network device 160c and the network device 160d in creating routes. Network routing information may comprise network information, including node information and connection information.

Turning to FIG. 1G, the user device 150 may transmit a request to the network device 160c. The request may comprise a network identifier. The network identifier may comprise a domain name. The domain name may comprise a hostname. The domain name may comprise a URI. The URI may comprise a URL, such as www.hostname.com. The network identifier may comprise a computer-readable network identifier. The network identifier may comprise a portion of a computer-readable network identifier, such as a prefix of an IP address. The request may be to access the server 170. The request may be associated with accessing the server 170. The request may be associated with a route to the server 170. Turning to FIG. 1H, the network device 160c may forward (transmit, route, etc.) the request to the DNS server 110. The network device 160c may extract the network identifier from the request and create a new message comprising the network identifier for transmission to the DNS server 110. Although FIGS. 1G and 1H show the network device 160c as an intermediate device between the user device 150 and the DNS server 110, the user device 150 may transmit the network identifier to the DNS server 110 via the direct connection between the user device 150 and the DNS server 110. Turning to FIG. 1I, the DNS server 110 may receive the request comprising the network identifier. The DNS server 110 may receive the new message comprising the network identifier. The DNS server 110 may extract the network identifier from the request and/or the new message. The DNS server 110 may use the network identifier to retrieve network routing information between the user device 150 and the server 170. The DNS server 110 may use the network identifier to retrieve network routing information between a network device in communication with the user device 150, such as the network device 160c, and the server 170. The DNS server 110 may use the network identifier to retrieve network routing information between the user device 150 and a network device in communication with the server 170, such as the network device 160e. The DNS server 110 may use the network identifier to retrieve network routing information between a network device in communication with the user device 150, such as the network device 160c, and a network device in communication with the server 170, such as the network device 160c. The DNS server 110 may transmit a response to the network device 160c, wherein the response comprises the network routing information.

Turning to FIG. 1J, the network device 160c may forward the response to the user device 150. The network device 160c may extract the network routing information and create a new response with the network routing information and forward the new response to the user device 150. The user device 150 may receive the response and/or the new response and extract the network routing information from the received response and/or new response. The user device 150 may use the network routing information to create a communication connection between the user device 150 and the server 170. Although shown as forwarding the network routing information to the user device 150 in FIG. 1J, in another embodiment, a network device, such as network device 160c, may use the network routing information to facilitate communication between the user device 150 and the server 170. Although FIGS. 1I and 1J show the network device 160c as an intermediate device between the user device 150 and the DNS server 110, the DNS server 110 may transmit the network routing information to the user device 150 via the direct connection between the user device 150 and the DNS server 110.

Turning to FIG. 1K, a communication route made using the network routing information between the user device 150 and the server 170 is shown.

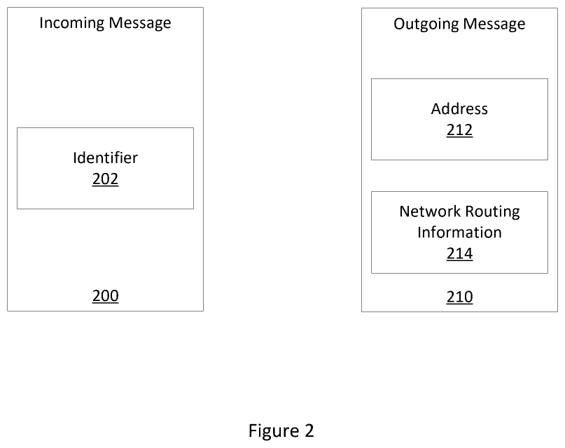

FIG. 2 shows example communication messages in a system for providing detailed network data using a DNS protocol. The example messages may comprise an incoming message 200 and an outgoing message 210. The incoming message 200 may comprise a format consistent with a format expected by a DNS server. The incoming message 200 may comprise an identifier field 202. The identifier field 202 may comprise an IP address prefix. The outgoing message 210 may comprise a format consistent with messages received from a DNS server. The outgoing message 210 may comprise an address field 212 and a network routing information field 214. The address field 212 may comprise an IP address. The address field 212 may comprise an IP address prefix. A longest prefix match (LPM) mechanism may be applied to data in an identifier field 202 of an incoming message 200 to determine an appropriate value for an address field 212 in a corresponding outgoing message 210. The network routing information field 214 may comprise a path. The network routing information field 214 may comprise data from a BGP table. The network routing information field 214 may comprise data from a RIB table. A user device, such as the user device 150 in FIG. 1, may transmit the incoming message 200 to a DNS server, such as the DNS server 110 in FIG. 1. In response to receiving the incoming message 200, the DNS server may transmit the outgoing message 210 to the user device. Data in the address field 212 and the network routing information field 214 of an outgoing message 210 may be associated with a computing device associated with data in an identifier field 202 of a corresponding incoming message 200.

The DNS server may maintain a table for storing network routing information for creating outgoing messages 210 in response to incoming messages 200. The maintained table may comprise a BGP table. The maintained table may comprise a RIB table. The maintained table may resolve differences in network routing information received from a plurality of network devices. The DNS server may update the maintained table with network routing information received from network devices. The DNS server may receive network routing information from network devices on a periodic basis. The DNS server may receive network routing information from network devices at regular time intervals. The DNS server may receive network routing information from network devices on a dynamic basis. The DNS server may receive network routing information in response to a trigger event. The trigger event may comprise a software update.

The DNS server may receive a query from a user device. The query may comprise an IP prefix (e.g., route, etc.). The DNS server may determine a corresponding best fit prefix by applying a longest prefix match mechanism to the IP prefix to obtain an outgoing IP prefix. The DNS server may retrieve network routing information associated with the outgoing IP prefix. The DNS server may return the outgoing IP prefix and network routing information in a record with a DNS TXT (text) format.

An example DNS query using the ‘dig’ DNS utility might be:
- - -
dig +short 1.1.4.1.slash.24.get-ip-info.comcast.net
- - -
returns
- - -
‘prefix: 1.0.4.0/22’
‘as-path: 174 7545 2764 38803’
- - -
or alternately in JSON (JavaScript Object Notation):
   ‘{“prefix”: “1.1.1.0/24”, “as-path”: “174 7545 2764 38803”}’

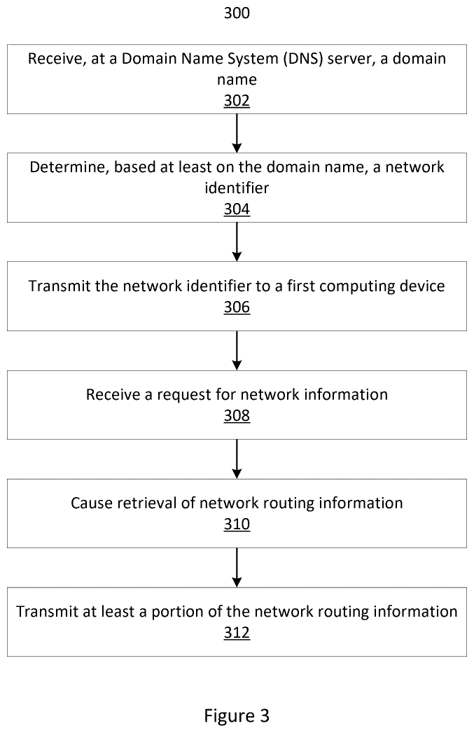

FIG. 3 is a flowchart of an example process 300. In some implementations, one or more process blocks of FIG. 3 may be performed by one or more devices.

As shown in FIG. 3, process 300 may include receiving, at a Domain Name System (DNS) server, a domain name, at 302. The domain name may comprise a hostname. The domain name may comprise a Uniform Resource Identifier (URI). The domain name may comprise a Uniform Resource Locator (URL).

As shown in FIG. 3, process 300 may include determining, based at least on the domain name, a network identifier, at 304. The network identifier may comprise a computer-readable network identifier. The network identifier may comprise an Internet Protocol (IP) address. The determining a network identifier based on the domain name may comprise a DNS resolution. The determining a network identifier based on the domain name may comprise applying the domain name to a lookup table and receive the network identifier.

As shown in FIG. 3, process 300 may include transmitting the network identifier to a first computing device, at 306. The first computing device may comprise a user device. The first computing device may comprise a network device.

As shown in FIG. 3, process 300 may include receiving a request for network information, at 308. The request may comprise a second network identifier. The second network identifier and/or the request may comprise a domain name. The second network identifier may be or comprise at least a portion of the network identifier. The request may be associated with a user device. The request may comprise a request for DNS resolution. The request for network information may comprise a permissionless query, which does not require additional authority or approvals to access the network information. For example, a request may be received at a DNS server and from a computing device. The computing device may comprise a user device. The request may be a DNS message indicative of a request for network information and/or DNS resolution. As an illustrative example, the second network identifier may be or comprise a network route. The second network identifier may be or comprise an Internet Protocol (IP) prefix. Other identifiers may be used. The second network identifier may comprise at least a portion of the first network identifier. The network routing information may comprise information associated with one or more of a Border Gateway Protocol (BGP) table or a Routing Information Base (RIB).

As also shown in FIG. 3, process 300 may include causing retrieval of network routing information, at 310. The DNS server may cause retrieval of the network routing information. The network routing information may be caused to be retrieved based on at least the second network identifier (e.g., at least a portion of the network identifier). The network routing information may be associated with a network device. The network device may comprise a network router. The network device may be in communication with the DNS server.

The network routing information may comprise one or more of nearest neighbor information, least hop information, shortest path information, or lowest latency information. As an example, the retrieval of the network routing information may comprise implementing one or more rules using the second network identifier, such as a longest prefix match rule or best match rule, for example using the second network identifier. As a further example, the network routing information may be retrieved from a data source without having to directly query any router on the network. The network routing information may be retrieved by the DNS server without the DNS server forwarding the request for network information to another computing device. The data source may be local to the DNS server or may be accessible over a network connection. The network routing information may comprise BGP information. The data store may comprise a Routing Information Base configured data store. The network routing information may comprise a RIB table and/or other RIB information. The data store may transmit network routing information directly to the DNS server. As an illustrative example, network device information relating to one or more network devices may be received by the DNS server on a period basis or may be retrieved based on a response to a trigger event such as a software update.

As further shown in FIG. 3, process 300 may include transmitting at least a portion of the network routing information, at 312. The at least a portion of the network routing information may be transmitted from the DNS server. The at least a portion of the network routing information may be transmitted to one or more of the first computing device or a second computing device. The second computing device may comprise a user device. The second computing device may comprise a network device. The network identifier and the at least a portion of the network routing information may be transmitted together or in separate communications. As an example, the DNS server may receive the domain name and may return the network routing information.

The process 300 may include receiving, at the DNS server, network device information from one or more network devices. The process 300 may include storing the network device information. The at least a portion of the network routing information may be retrieved from the network device information. The DNS server may not transmit data to the one or more network devices. The network device information may be received at regular time intervals or in response to a trigger event.

Although FIG. 3 shows example blocks of process 300, in some implementations, process 300 may include additional blocks, fewer blocks, different blocks, or differently arranged blocks than those depicted in FIG. 3. Additionally, or alternatively, two or more of the blocks of process 300 may be performed in parallel.

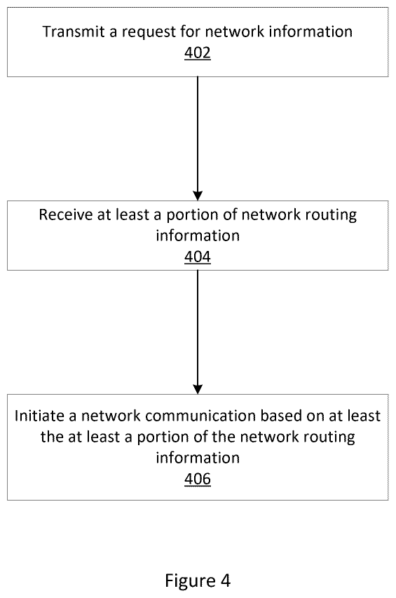

FIG. 4 is a flowchart of an example process 400. In some implementations, one or more process blocks of FIG. 4 may be performed by one or more devices.

As shown in FIG. 4, process 400 may include transmitting a request for network information, at 402. The request for network information may be transmitted from a user device. The request for network information may be transmitted to a Domain Name System (DNS) server. The request may include an identifier. The DNS server may retrieve, based on at least the identifier, network routing information. The network routing information may be associated with a network device. The network device may be in communication with the DNS server. The request for network information may comprise a permissionless query. The identifier may comprise one or more of a network route or an Internet Protocol (IP) prefix. The DNS server may implement one or more of a longest prefix match rule or a best match rule using the identifier to retrieve the network routing information. The network routing information may be retrieved from a data source local to the DNS server. The network routing information may comprise information associated with one or more of a Border Gateway Protocol (BGP) table or a Routing Information Base (RIB).

As also shown in FIG. 4, process 400 may include receiving at least a portion of the network routing information, at 404. The at least a portion of the network routing information may be received from the DNS server.

As further shown in FIG. 4, process 400 may include initiating a network communication based on at least the at least a portion of the network routing information, at 406. The network communication may be initiated from the user device.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

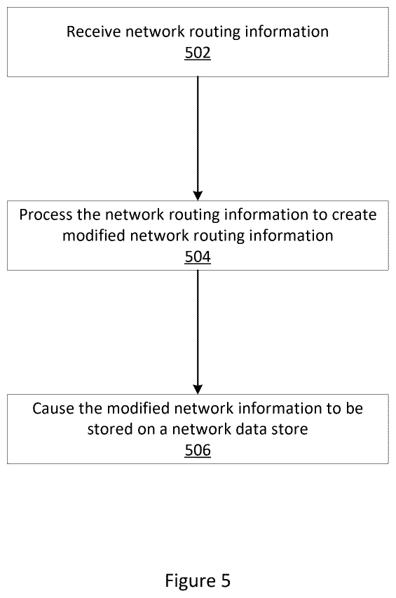

FIG. 5 is a flowchart of an example process 500. In some implementations, one or more process blocks of FIG. 5 may be performed by a device such as the intermediate processing device, which may be embodied as network hardware, software, firmware, or a combination thereof.

As shown in FIG. 5, process 500 may include receiving network routing information, at 502. The network routing information may be received at an intermediate processing device. The intermediate processing device may be in network communication with one or more network devices and a Domain Name System (DNS) server. The network routing information may be associated the with one or more network devices. The network routing information may be or comprise information associated with one or more of a Border Gateway Protocol (BGP) table or a Routing Information Base (RIB).

As also shown in FIG. 5, process 500 may include processing the network routing information to create modified network routing information, at 504. The intermediate processing device may process the network routing information to create modified network routing information. The network routing information may be processed to include metadata. The intermediate device may be configured to organize data into a data structure, such as a table. The intermediate processing device may be configured to resolve conflicts in network routing information received from routers. The intermediate processing device may be configured to cache data received from the one or more network devices. The intermediate processing device may aggregate routing data from one or more routers (e.g., router 120) across a network and may combine the aggregated data into a unified data structure. The intermediate processing device may modify the data with additional metadata such as geo-location or topology information to show details on the source of the data. Other metadata and information may be added. The intermediate processing device may add timing information indicating when the data was retrieved from a given router (e.g., router 120). The intermediate processing device may be configured to calculate Domain Name System Security Extensions (DNSSEC) signature records for the data to validate the authenticity of the data to end users. The intermediate processing device may calculate alternate paths for routing flows through the network. The intermediate processing device may be configured to manage the periodic retrieval of all types of data from one or more routers (e.g., router 120). The retrieval period may be undefined or may be fixed or vary over a timing algorithm based on time of day, day of week, or month of year. Other operations may be implemented via the intermediate processing device.

As further shown in FIG. 5, process 500 may include causing the modified network routing information to be stored on a network data store, at 506. The DNS server may be configured to access the data store to retrieve the modified network routing information without having to directly communicate with the one or more network devices.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

The present disclosure includes at least the following examples:

Example 1: A method may include: receiving, at a Domain Name System (DNS) server, a domain name; determining, based at least on the domain name, a first network identifier; transmitting the first network identifier to a first computing device; receiving, at the DNS server, a request for network information, where the request may include a second network identifier; causing retrieval, via the DNS server and based on at least the second network identifier, of network routing information associated with a network device, where the network routing information may include one or more of an indication of nearest neighbor information, least hop information, shortest path information, or lowest latency information; and transmitting, from the DNS server, at least a portion of the network routing information to one or more of the first computing device or a second computing device.

Example 2: The method of Example 1, where the request for network information may include a permissionless query.

Example 3: The method of Example 1 or Example 2, where the second network identifier may include one or more of a network route or an Internet Protocol (IP) prefix.

Example 4: The method of any one of Examples 1-3, where the retrieval of the network routing information may include implementing one or more of a longest prefix match rule using the second network identifier or a best match rule using the second network identifier.

Example 5: The method of any one of Examples 1-4, where the network routing information is retrieved from a data source local to the DNS server.

Example 6: The method of any one of Examples 1-5, where the network routing information may include information associated with one or more of a Border Gateway Protocol (BGP) table or a Routing Information Base (RIB).

Example 7: The method of any one of Examples 1-6, where the request for network information is not forwarded to another computing device by the DNS server.

Example 8: The method of any one of Examples 1-7, where the second network identifier may include at least a portion of the first network identifier.

Example 9: The method of any one of Examples 1-8, where the network device may include a network router.

Example 10: The method of any one of Examples 1-9, further may include: receiving, at the DNS server, network device information from one or more network devices; and storing the network device information, where the at least a portion of the network routing information is retrieved from the network device information.

Example 11: The method of any one of Examples 1-10, where the DNS server does not transmit data to the one or more network devices.

Example 12: The method of any one of Examples 1-11, where the network device information is received at regular time intervals or in response to a trigger event.

Example 13: A method may include: transmitting, from a user device and to a Domain Name System (DNS) server, a request for network information, where the request may include an identifier, where the DNS server is configured to retrieve, based on at least the identifier, network routing information associated with a network device in communication with the DNS server; receiving, via the DNS server, at least a portion of the network routing information; and initiating, from the user device, a network communication based on at least the at least a portion of the network routing information.

Example 14: The method of Example 13, where the request for network information may include a permissionless query.

Example 15: The method of Example 13 or Example 14, where the identifier may include one or more of a network route or an Internet Protocol (IP) prefix.

Example 16: The method of any one of Examples 13-15, where the DNS server implements one or more of a longest prefix match rule or a best match rule using the identifier to retrieve the network routing information.

Example 17: The method of any one of Examples 13-16, where the network routing information is retrieved from a data source local to the DNS server.

Example 18: The method of any one of Examples 13-17, where the network routing information may include information associated with one or more of a Border Gateway Protocol (BGP) table or a Routing Information Base (RIB).

Example 19: A method may include: receiving, at an intermediate processing device in network communication with one or more network devices and a Domain Name System (DNS) server, network routing information associated with the one or more network devices; processing, via the intermediate processing device, the network routing information to include metadata to create modified network routing information; and causing the modified network routing information to by stored on a network data store, where the DNS server is configured to access the data store to retrieve the modified network routing information without having to directly communicate with the one or more network devices.

Example 20: The method of Example 19, where the network routing information may include information associated with one or more of a Border Gateway Protocol (BGP) table or a Routing Information Base (RIB).

The foregoing disclosure provides illustration and description but is not intended to be exhaustive or to limit the implementations to the precise form disclosed. Modifications may be made in light of the above disclosure or may be acquired from practice of the implementations. As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein. As used herein, satisfying a threshold may, depending on the context, refer to a value being greater than the threshold, greater than or equal to the threshold, less than the threshold, less than or equal to the threshold, equal to the threshold, and/or the like, depending on the context. Although particular combinations of features are recited in the claims and/or disclosed in the specification, these combinations are not intended to limit the disclosure of various implementations. In fact, many of these features may be combined in ways not specifically recited in the claims and/or disclosed in the specification

Although each dependent claim listed below may directly depend on only one claim, the disclosure of various implementations includes each dependent claim in combination with every other claim in the claim set. No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A method comprising:
receiving, at a Domain Name System (DNS) server, a domain name;
determining, based at least on the domain name, a network identifier;
causing retrieval, via the DNS server and based on at least a portion of the network identifier, of network routing information associated with a network device; and
transmitting, from the DNS server, at least a portion of the network routing information to one or more computing devices.

2. The method of claim 1, wherein the domain is received via a permissionless query.

3. The method of claim 1, wherein the network identifier comprises an Internet Protocol (IP) address.

4. The method of claim 1, wherein the at least a portion of the network identifier comprises one or more of a network route or an Internet Protocol (IP) prefix.

5. The method of claim 1, wherein the retrieval of the network routing information comprises implementing one or more of a longest prefix match rule using the at least a portion of the network identifier or a best match rule using the at least a portion of the network identifier.

6. The method of claim 1, wherein the network routing information is retrieved from a data source local to the DNS server.

7. The method of claim 1, wherein the network routing information comprises information associated with one or more of a Border Gateway Protocol (BGP) table or a Routing Information Base (RIB).

8. The method of claim 1, wherein the network routing information comprises one or more of an indication of nearest neighbor information, least hop information, shortest path information, or lowest latency information.

9. The method of claim 1, wherein the network device comprises a network router.

10. The method of claim 1, further comprising:
receiving, at the DNS server, network device information from one or more network devices; and
storing the network device information, wherein the at least a portion of the network routing information is retrieved from the network device information.

11. The method of claim 10, wherein the DNS server does not transmit data to the one or more network devices.

12. The method of claim 10, wherein the network device information is received at regular time intervals or in response to a trigger event.

13. A method comprising:
transmitting, from a user device and to a Domain Name System (DNS) server, a request for network information, wherein the request comprises an identifier, wherein the DNS server is configured to retrieve, based on at least the identifier, network routing information associated with a network device, wherein the network routing information comprises one or more of an indication of nearest neighbor information, least hop information, shortest path information, or lowest latency information;
receiving, via the DNS server, at least a portion of the network routing information; and
initiating, from the user device, a network communication based on at least the at least a portion of the network routing information.

14. The method of claim 13, wherein the request for network information comprises a permissionless query.

15. The method of claim 13, wherein the identifier comprises one or more of a network route or an Internet Protocol (IP) prefix.

16. The method of claim 13, wherein the DNS server implements one or more of a longest prefix match rule or a best match rule using the identifier to retrieve the network routing information.

17. The method of claim 13, wherein the network routing information is retrieved from a data source local to the DNS server.

18. The method of claim 13, wherein the network routing information comprises information associated with one or more of a Border Gateway Protocol (BGP) table or a Routing Information Base (RIB).

19. A method comprising:
receiving, at an intermediate processing device in network communication with one or more network devices and a Domain Name System (DNS) server, network routing information associated with the one or more network devices;
processing, via the intermediate processing device, the network routing information to include metadata to create modified network routing information; and
causing the modified network routing information to by stored on a network data store, wherein the DNS server is configured to access the data store to retrieve the modified network routing information without having to directly communicate with the one or more network devices.

20. The method of claim 19, wherein the network routing information comprises information associated with one or more of a Border Gateway Protocol (BGP) table or a Routing Information Base (RIB).
